(19) United States
(12) Patent Application Publication
(10) Pub. No.: US 2026/0312101 A1
(43) Pub. Date: Oct. 8, 2026

(54) PRIME LOCATION OF UNIPOLAR ELECTROLYSIS PLANTS ON THE ELECTRICITY GRID

(71) Applicant: Rodolfo Antonio M. Gomez, Netley (AU)

(72) Inventor: Rodolfo Antonio M. Gomez, Netley (AU)

(21) Appl. No.: 19/482,964

(22) PCT Filed: May 9, 2024
(86) PCT No.: PCT/AU2024/050456

§ 371 Date: Nov. 10, 2025

(30) Foreign Application Priority Data
May 9, 2023 (AU) 2023901397

(51) Int. Cl. H01M 8/0656; H02J 3/38; H02J 15/50; H02J 101/24; H02J 101/28; H02J 101/30; H02J 101/40

(52) U.S. Cl. CPC H01M 8/0656; H02J 3/38; H02J 15/50; H01M 2250/10; H02J 2101/24; H02J 2101/28; H02J 2101/30; H02J 2101/40

(57) ABSTRACT

An apparatus for generating electrical energy is disclosed. The apparatus comprises an electrolytic hydrogen generator configured to receive electricity from at least one renewable electricity generating source and produce hydrogen and oxygen from water. The apparatus also comprises a hydrogen storage unit configured to store hydrogen produced by the electrolytic hydrogen generator and a plurality of hydrogen fuel cells in fluid connection with the hydrogen storage unit and a source of oxygen or air, each hydrogen fuel cell configured to generate electricity from hydrogen supplied from the hydrogen storage unit and oxygen or air supplied from the source of oxygen or air.

### PRIORITY DOCUMENT

The present application claims priority from Australian Provisional Patent Application No. 2023901397 titled “PRIME LOCATION OF UNIPOLAR ELECTROLYSIS PLANTS ON THE ELECTRICITY GRID” and filed on 9 May 2023, the content of which is hereby incorporated by reference in its entirety.

### INCORPORATION BY REFERENCE

U.S. Pat. No. 10,316,416 is referred to in the present application and its contents is hereby incorporated by reference in its entirety.

### TECHNICAL FIELD

The present disclosure relates to electricity production.

### BACKGROUND

To reduce the production of greenhouse gases and prevent catastrophic climate change, there is an increasing worldwide need for electricity to be generated from renewable energy sources. However, renewable energy sources generate most of their energy at certain times of the day, which are not necessarily at peak demand hours. As a result, there is inconsistency in generation and inconsistency in loads.

There is a need for systems that can supply electricity on demand wherein at least part of the electricity demand is derived from renewable sources.

### SUMMARY

The present disclosure arises from the inventor's long term work using so-called unipolar electrolysis. For example, U.S. Pat. No. 10,316,416 provides that hydrogen can be produced in a unipolar electrolysis apparatus from 5.37 kilowatt-hours per kilogram (kwh/kg). The present disclosure involves carrying out unipolar electrolysis in one or more stages. For example, electricity from a solar or wind farm is used to produce hydrogen. Since the electricity is cyclic, the hydrogen is stored and then fed to a hydrogen fuel cell on demand. This is Stage 1. The electricity from Stage 1 is then used to power a second electrolyser and the hydrogen produced is stored to account for normal varying demand from the second hydrogen fuel cell. The second hydrogen fuel cell produces substantially more electricity.

Thus, in a first aspect provided herein is an apparatus for generating electrical energy, the apparatus comprising:
an electrolytic hydrogen generator configured to receive electricity from at least one renewable electricity generating source and produce hydrogen and oxygen from water;
a hydrogen storage unit configured to store hydrogen produced by the electrolytic hydrogen generator;
a plurality of hydrogen fuel cells in fluid connection with the hydrogen storage unit and a source of oxygen or air, each hydrogen fuel cell configured to generate electricity from hydrogen supplied from the hydrogen storage unit and oxygen or air supplied from the source of oxygen or air.

In certain embodiments of the first aspect, the apparatus further comprises, for each hydrogen fuel cell:
an additional electrolytic hydrogen generator configured to receive electricity from the hydrogen fuel cell and produce hydrogen and oxygen from water;
an additional hydrogen storage unit configured to store hydrogen produced by the additional electrolytic hydrogen generator; and
a plurality of additional hydrogen fuel cells in fluid connection with the additional hydrogen storage unit and a source of oxygen or air, each additional hydrogen fuel cell configured to generate electricity from hydrogen supplied from the additional hydrogen storage unit and oxygen or air supplied from the source of oxygen or air.

In certain embodiments of the first aspect, the electrolytic hydrogen generator and/or the additional electrolytic hydrogen generator comprises at least one unipolar electrolytic cell.

The apparatus for generating electrical energy of the first aspect may be ideally connected to an existing electricity grid system such as a coal or gas fired electricity grid system. This allows an electricity generation system that is powered from renewable sources to be fitted into an existing electricity grid system.

Thus, in a second aspect, provided herein is a grid scale electrical energy generation system comprising:
at least one renewable electricity generating source;
the apparatus for generating electrical energy of the first aspect configured to receive electrical input from the at least one renewable electricity generating source; and
an electricity grid system configured to deliver electricity to end users.

In a third aspect, disclosed herein is a method for generating electrical energy, the method comprising:
providing electricity from at least one renewable energy source to an electrolytic hydrogen generator to produce hydrogen and oxygen from water;
feeding hydrogen produced by the electrolytic hydrogen generator to a hydrogen storage unit configured to store hydrogen;
feeding hydrogen from the hydrogen storage unit to a plurality of hydrogen fuel cells in fluid connection with the hydrogen storage unit and a source of oxygen or air; and
generating electricity in each hydrogen fuel cell from hydrogen supplied from the hydrogen storage unit and oxygen or air supplied from the source of oxygen or air.

In certain embodiments of the third aspect, the method further comprises:
providing electricity generated in each hydrogen fuel cell to an additional electrolytic hydrogen generator configured to receive electricity from the hydrogen fuel cell and produce hydrogen and oxygen from water;
feeding hydrogen produced at each additional electrolytic hydrogen generator to an additional hydrogen storage unit configured to store hydrogen produced by each additional electrolytic hydrogen generator; and
feeding hydrogen from each additional hydrogen storage unit to a plurality of additional hydrogen fuel cells in fluid connection with each additional hydrogen storage unit and a source of oxygen or air; and
generating electricity from each additional hydrogen fuel cell from hydrogen supplied from each additional hydrogen storage unit and oxygen or air supplied from the source of oxygen or air.

In certain embodiments of the third aspect, the electrolytic hydrogen generator and/or the additional electrolytic hydrogen generator comprises at least one unipolar electrolytic cell.

### BRIEF DESCRIPTION OF THE FIGURES

Embodiments of the present disclosure will be discussed with reference to the accompanying figures wherein:

FIG. 1 is a schematic illustration of an apparatus for generating electrical energy according to embodiments of the present disclosure; and

FIG. 2 is a schematic diagram of an apparatus for generating electrical energy according to FIG. 1 and showing the location of the apparatus at an existing coal or gas fired power station.

### DESCRIPTION OF EMBODIMENTS

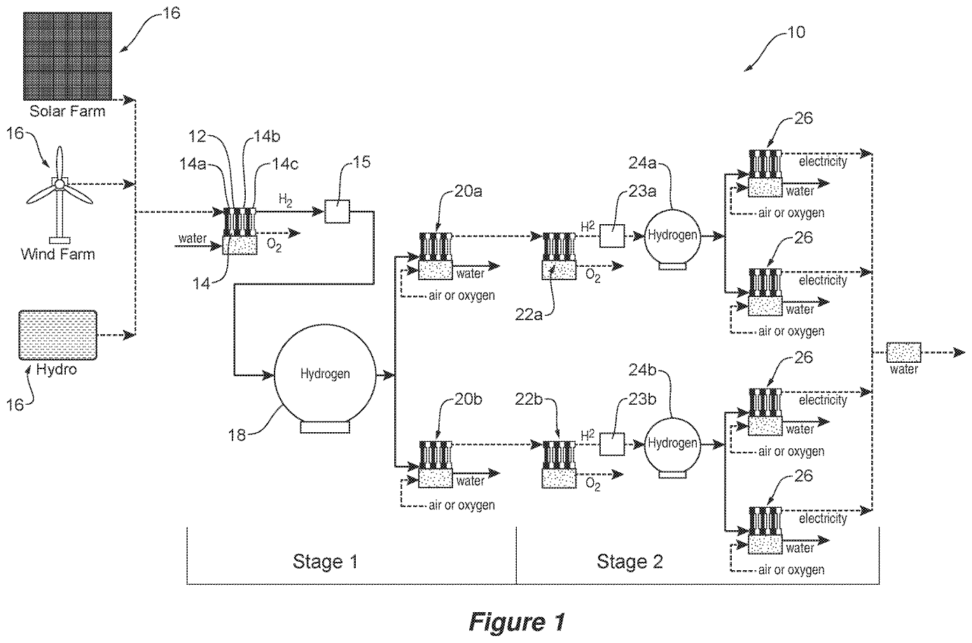

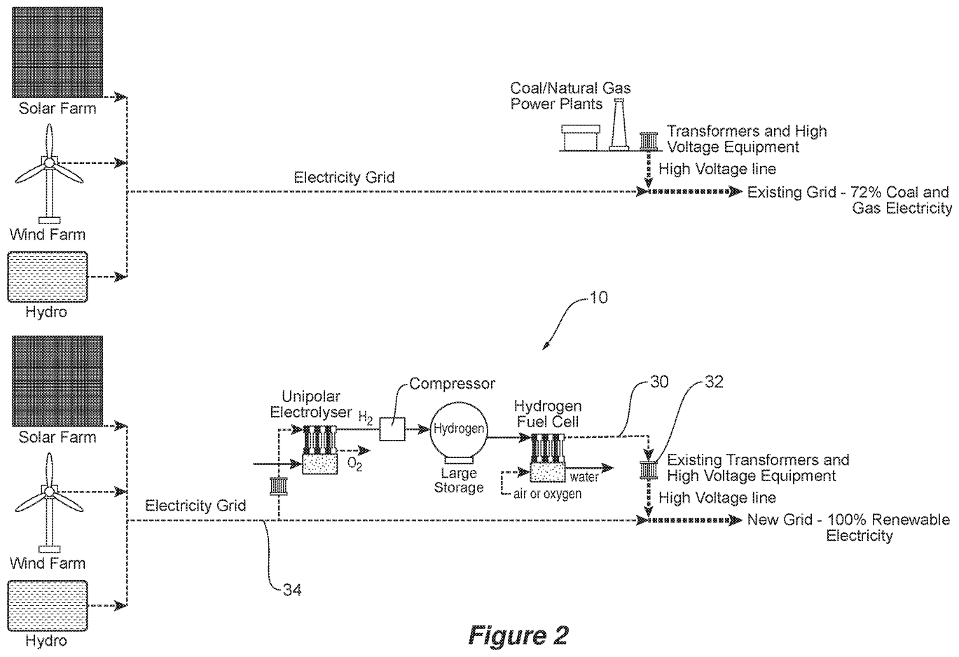

Referring to FIG. 1, disclosed herein is an apparatus 10 for generating electrical energy. The apparatus 10 comprises an electrolytic hydrogen generator 12. In the illustrated embodiments, the electrolytic hydrogen generator 12 comprises at least one unipolar electrolytic cell 14. The electrolytic hydrogen generator 12 is configured to receive electricity from at least one renewable electricity generating source 16 and produce hydrogen and oxygen from water. The apparatus 10 also comprises a hydrogen storage unit 18 configured to store hydrogen produced by the electrolytic hydrogen generator 12 and a plurality of hydrogen fuel cells 20 in fluid connection with the hydrogen storage unit 18 unit and a source of oxygen or air. Each hydrogen fuel cell 20 is configured to generate electricity from hydrogen supplied from the hydrogen storage unit 18 and oxygen or air supplied from the source of oxygen or air. This is referred to as ‘Stage 1’ herein and is illustrated as a stand alone unit in FIG. 2.

Also shown in FIG. 1 is an apparatus for carrying out ‘Stage 2’ in which the apparatus 10 further comprises, for each hydrogen fuel cell 20, an additional electrolytic hydrogen generator 22 configured to receive electricity from each hydrogen fuel cell 20 and produce hydrogen and oxygen from water. The apparatus 10 also comprises an additional hydrogen storage unit 24 configured to store hydrogen produced by the electrolytic hydrogen generator 22 and a plurality of additional hydrogen fuel cells 26 in fluid connection with the additional hydrogen storage unit 24 and a source of oxygen or air. Each additional hydrogen fuel cell 26 is configured to generate electricity from hydrogen supplied from the additional hydrogen storage unit 24 and oxygen or air supplied from the source of oxygen or air.

In the illustrated embodiments, the electrolytic hydrogen generator 12 comprises at least one unipolar electrolytic cell 14, although the apparatus 10 is not limited to those particular embodiments and other electrolytical cells capable of producing hydrogen could be used. In the illustrated embodiments, use of the apparatus 10 involves carrying out unipolar electrolysis in one or more stages. For example, electricity from a solar or wind farm 16 is used to produce hydrogen. Since the electricity is cyclic, the hydrogen is stored in the hydrogen storage unit 18 and then fed to a hydrogen fuel cell 20 on demand. This is Stage 1 and this is illustrated in FIG. 2. In Stage 2, the electricity from Stage 1 is used to power a second electrolyser (i.e. additional electrolytic hydrogen generator 22) and the hydrogen produced is stored in hydrogen storage unit 24 to account for normal varying demand from the additional hydrogen fuel cell 26 (i.e. second hydrogen fuel cell).

Each additional hydrogen fuel cell 26 (i.e. second hydrogen fuel cell) produces substantially more electricity. Based on the data for Australian renewable electricity production for 2021, applying Stage 2, the renewable cyclic energy starts at 73,786 Gigawatt-hours (GWH) and after Stage 1 there is 70,105 GWH generated at each of two hydrogen fuel cells 20. At Stage 2, 74,873 GWH is produced at each of four fuel cells 26 which means that electricity is available continuously at 299,490 GWH. This is an increase of four times the starting renewable energy.

The renewable electricity used in the apparatus 10 can be obtained from renewable energy derived from natural sources that are replenished at a higher rate than they are consumed. Sunlight and wind, for example, are such sources that are constantly being replenished. Suitable renewable sources are biomass, nuclear power, geothermal, wind energy, solar power, tidal power, and wave power. Apparatus for generating electricity from each of these renewable sources are known and can be used herein.

The renewable electricity is used to power the electrolytic hydrogen generator 12 comprising at least one unipolar electrolytic cell 14. As used herein, the term “unipolar electrolytic cell” and related terms means a diaphragm type unipolar electrolysis described in U.S. Pat. No. 10,316,416. Briefly, the unipolar electrolytic cell 14 comprises an anode cell and a cathode cell. The anode cell comprises an anode electrode and an anode cell solution electrode. The cathode cell comprises a cathode electrode and a cathode cell solution electrode. A direct electric current is applied to the anode electrode and cathode solution electrode. The direct electric current is usually a steady current, but in some embodiments a pulsed direct current is applied to the anode electrode and the cathode solution electrode. The frequency may range up to several thousand cycles per second and the amplitude may range up to 100 times the average of the direct current. Large surface area contact between the electrodes and the electrolyte can be achieved by the construction of the electrode such as a gauze or expanded metal construction where the electrolyte is passed through the electrode.

Any number of anode and cathode electrodes can be present in the electrolytic cell 14. The electrolytic hydrogen generator 12 may comprise more than one electrolytic cell 14, such as three electrolytic cells, a first electrolytic cell 14a, a second electrolytic cell 14b and a third electrolytic cell 14c, each having an anode compartment and a cathode compartment separated by a diaphragm. The first electrolytic cell 14a serves as the electrolytic section where electric power is applied. The first electrolytic cell 14a comprises an anode electrode and a cathode electrode. The anode and cathode electrodes are formed of a porous material such as expanded mesh or similar construction. Each of the anode compartments and cathode compartments further comprise a plurality of baffles which assist to facilitate movement and flow of electrolyte solutions throughout the compartments. The anode electrodes and cathode electrodes, for example, can be formed from titanium mesh. Further, the anode electrodes and cathode electrodes may be coated with a suitable catalyst to favour the reaction that is desired at the respective electrodes, such as platinum, platinum group oxides or metals such as nickel, cobalt, molybdenum or alloys or oxides of these precious and base metals. For example, the cathode electrodes that produce hydrogen may be coated with a catalyst having different ratios of the platinum group oxides.

A second electrolytic cell 14b serves as a neutralization section, comprising an anode compartment and a cathode compartment and houses an anode electrode and a cathode electrode, respectively. The second electrolytic cell allows the neutralisation of negatively charged acidic electrolyte solution and positively charged alkaline electrolyte solution, exiting from the first electrolytic cell 14a.

Unipolar electrolysis of water may also refer to a diaphragm-less electrolytic cell having an anode cell and a cathode cell connected by a DC power source and an external conductor, such as is disclosed in U.S. Pat. No. 7,326,329.

The present disclosure arises from the inventor's extensive research using unipolar electrolysis. For example, U.S. Pat. No. 10,316,416 shows that hydrogen can be produced in a unipolar electrolysis apparatus from 5.37 kilowatt-hours per kilogram (kwh/kg). If the electrolyser efficiency is increased to 10 kwh/kg, there will be an energy gain because hydrogen has an energy content of 33.33 kwh/kg. If the hydrogen fuel cell has an efficiency of 85%, the electrical output from the hydrogen fuel cell will be 33.33×85/100=28.33 kwh/kg.

Hydrogen produced by the electrolytic hydrogen generator 12 is transferred via standard pipe work to a cooler/compressor 15 and then to hydrogen storage unit 18 which is configured to store the hydrogen. The hydrogen storage unit 18 may be a hydrogen storage tank. Hydrogen storage tanks are commercially available, and any suitable tank can be used. Storage of hydrogen as a gas typically requires 350-700 bar tanks.

The hydrogen storage unit 18 is fluidly connected to the plurality of hydrogen fuel cells 20. In the illustrated embodiments, the apparatus comprises two hydrogen fuel cells 20a and 20b in fluid connection with the hydrogen storage unit 18. Each hydrogen fuel cell 20a and 20b is in fluid connection with a source of air or oxygen. For simplicity, air can be used. Each hydrogen fuel cell 20a and 20b generates electrical energy from the hydrogen and oxygen or air, as is known in the art.

Any suitable hydrogen fuel cell 20 can be used. For example, the hydrogen fuel cell 20 may comprise an anode cell and a cathode cell as is known. An electrolyte in the anode cell is alkaline, the electrolyte being, for example, potassium hydroxide and the same at the cathode cell. The anode electrode is a conductor coated with a catalyst such as platinum while the cathode is a conductor coated with a catalyst such as iridium. A membrane that is non-conductive, but allows hydrogen protons to pass through, separates the anode cell from the from the cathode cell. When hydrogen is applied at the anode, the hydrogen is catalysed into protons and electrons, with the reaction:

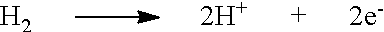

The protons pass through the membrane to the cathode cell while the electrons on the anode electrode pass through the external circuit through the electrical load and into the cathode electrode. The protons, electrons and oxygen introduced into the cathode cell react to complete the fuel cell reaction:

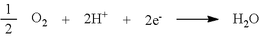

Similarly, the electrolytes at the anode cell and at the cathode cell can be acid such as phosphoric acid, the process of the fuel cell is the same.

Electrical energy produced in the hydrogen fuel cells 20a and 20b is then used by the additional unipolar electrolytic cells 22a and 22b in Stage 2. Water produced by the hydrogen fuel cells 20a and 20b is directed to a water storage tank to be fed back to the unipolar electrolytic cells 12.

In Stage 2, the additional unipolar electrolytic cells 22a and 22b produce hydrogen and oxygen. Hydrogen produced in the additional unipolar electrolytic cell 22a is fed via a cooler/compressor 23a to a small-scale additional hydrogen storage unit 24a and hydrogen produced in the additional unipolar electrolytic cell 22b is fed via a cooler/compressor 23b to a small-scale additional hydrogen storage unit 24b.

Each of the additional hydrogen storage units 24a and 24b provide a supply of hydrogen to a plurality of additional hydrogen fuel cells 26. In the illustrated embodiments, each additional hydrogen storage unit 24a and 24b provides a supply of hydrogen to two additional hydrogen fuel cells 26. Each hydrogen fuel cell 26 produces electricity from hydrogen supplied from the additional hydrogen storage units 24a or 24b and oxygen from a source of oxygen or air.

As shown in FIG. 2, the electrical energy output from the apparatus 10 can be fed via line 30 to an inverter 32 and into an electricity grid system 34 utilizing existing transformers and high voltage equipment. For example, the apparatus 10 may be located at the site of an existing coal power plant or natural gas power plant that the renewable energy will replace.

Thus, also provided herein, is a grid scale electrical energy generation system comprising at least one renewable electricity generating source 16, the apparatus for generating electrical energy 10 configured to receive electrical input from the at least one renewable electricity generating source 16, and an electricity grid system 34 configured to deliver electricity to end users. This enables electricity to be produced when the sun is not shining, or the wind is not blowing by using the hydrogen that is stored. The production of green electricity is more independent of sun and wind.

Locating the apparatus as described provides the following benefits:
a. Existing renewable energy sources are connected to the grid. This allows the location of the apparatus 10 at a coal or natural gas power plant site;
b. the electrolyser of Stage 1 can be powered from the grid if required;
c. the electricity produced from the additional fuel cells can make use of the exiting transformers, high voltage equipment, and high voltage transmission lines;

Also disclosed herein is a method for generating electrical energy. The method comprises providing electricity from at least one renewable energy source 16 to an electrolytic hydrogen generator 12 to produce hydrogen and oxygen from water. Hydrogen produced by the electrolytic hydrogen generator 12 is fed to a hydrogen storage unit 18 configured to store hydrogen. Hydrogen from the hydrogen storage unit 18 is then fed to a plurality of hydrogen fuel cells 20 in fluid connection with the hydrogen storage unit 18 and a source of oxygen or air. Electricity is generated in each hydrogen fuel cell 20 from hydrogen supplied from the hydrogen storage unit 18 and oxygen or air supplied from the source of oxygen or air.

The method may further comprise providing electricity generated in each hydrogen fuel cell 20 to an additional electrolytic hydrogen generator 22 configured to receive electricity from the hydrogen fuel cell 20 and produce hydrogen and oxygen from water. Hydrogen produced at each additional electrolytic hydrogen generator 22 is fed to an additional hydrogen storage unit 24 configured to store hydrogen produced by each additional electrolytic hydrogen generator 22. Hydrogen from each additional hydrogen storage unit 24 is fed to a plurality of additional hydrogen fuel cells 26 in fluid connection with each additional hydrogen storage unit 24 and a source of oxygen or air. Electricity is generated from each additional hydrogen fuel cell 26 from hydrogen supplied from each additional hydrogen storage unit 24 and oxygen or air supplied from the source of oxygen or air.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

What is claimed:

1. An apparatus for generating electrical energy, the apparatus comprising:
an electrolytic hydrogen generator configured to receive electricity from at least one renewable electricity generating source and produce hydrogen and oxygen from water;
a hydrogen storage unit configured to store hydrogen produced by the electrolytic hydrogen generator;
a plurality of hydrogen fuel cells in fluid connection with the hydrogen storage unit and a source of oxygen or air, each hydrogen fuel cell configured to generate electricity from hydrogen supplied from the hydrogen storage unit and oxygen or air supplied from the source of oxygen or air.

2. The apparatus of claim 1 further comprising, for each hydrogen fuel cell:
an additional electrolytic hydrogen generator configured to receive electricity from the hydrogen fuel cell and produce hydrogen and oxygen from water;
an additional hydrogen storage unit configured to store hydrogen produced by the additional electrolytic hydrogen generator; and
a plurality of additional hydrogen fuel cells in fluid connection with the additional hydrogen storage unit and a source of oxygen or air, each additional hydrogen fuel cell configured to generate electricity from hydrogen supplied from the additional hydrogen storage unit and oxygen or air supplied from the source of oxygen or air.

3. The apparatus of claim 2, wherein the electrolytic hydrogen generator and/or the additional electrolytic hydrogen generator comprises at least one unipolar electrolytic cell.

4. A grid scale electrical energy generation system comprising:
at least one renewable electricity generating source;
the apparatus for generating electrical energy of claim 1 configured to receive electrical input from the at least one renewable electricity generating source; and
an electricity grid system configured to deliver electricity to end users.

5. A method for generating electrical energy, the method comprising:
providing electricity from at least one renewable energy source to an electrolytic hydrogen generator to produce hydrogen and oxygen from water;
feeding hydrogen produced by the electrolytic hydrogen generator to a hydrogen storage unit configured to store hydrogen;
feeding hydrogen from the hydrogen storage unit to a plurality of hydrogen fuel cells in fluid connection with the hydrogen storage unit and a source of oxygen or air; and
generating electricity in each hydrogen fuel cell from hydrogen supplied from the hydrogen storage unit and oxygen or air supplied from the source of oxygen or air.

6. The method of claim 5 further comprising:
providing electricity generated in each hydrogen fuel cell to an additional electrolytic hydrogen generator configured to receive electricity from the hydrogen fuel cell and produce hydrogen and oxygen from water;
feeding hydrogen produced at each additional electrolytic hydrogen generator to an additional hydrogen storage unit configured to store hydrogen produced by each additional electrolytic hydrogen generator; and
feeding hydrogen from each additional hydrogen storage unit to a plurality of additional hydrogen fuel cells in fluid connection with each additional hydrogen storage unit and a source of oxygen or air; and
generating electricity from each additional hydrogen fuel cell from hydrogen supplied from each additional hydrogen storage unit and oxygen or air supplied from the source of oxygen or air.

7. The method of claim 5, wherein the electrolytic hydrogen generator and/or the additional electrolytic hydrogen generator comprises at least one unipolar electrolytic cell.
